(19) United States
(12) Patent Application Publication
(10) Pub. No.: US 2023/0371606 A1
(43) Pub. Date: Nov. 23, 2023

(54) A NON-COMBUSTIBLE AEROSOL PROVISION DEVICE AND A POWER MODULE FOR A NON-COMBUSTIBLE AEROSOL PROVISION DEVICE

(71) Applicant: Nicoventures Trading Limited, LONDON (GB)

(72) Inventor: Zhihuang XIAO, London (GB)

(21) Appl. No.: 18/044,714

(22) PCT Filed: Sep. 15, 2021
(86) PCT No.: PCT/EP2021/075382

§ 371 Date: Mar. 9, 2023

(30) Foreign Application Priority Data
Sep. 15, 2020 (GB) 2014521.5

(51) Int. Cl. A24F 40/50; A24F 40/46

(52) U.S. Cl. CPC A24F 40/50; A24F 40/46

(57) ABSTRACT

Described herein is a non-combustible aerosol provision device. The aerosol provision device includes an aerosol generator configured to cause aerosol to be generated from aerosol-generating material; a first electrical power source for powering the aerosol generator; and a connector for selectively connecting the non-combustible aerosol provision device to a power module. The power module includes a second electrical power source for powering the aerosol generator. The non-combustible aerosol provision device is configured such that the non-combustible aerosol provision device is settable in a first power mode when the power module is not connected to the non-combustible aerosol provision device and is settable in a second different power mode when the power module is connected to the non-combustible aerosol provision device, wherein the first and second power modes each determines the supply of electrical power to the aerosol generator.

### PRIORITY CLAIM

The present application is a National Phase entry of PCT Application No. PCT/EP2021/075382, filed Sep. 15, 2021, which claims priority from GB Application No. 2014521.5, filed Sep. 15, 2020, each of which hereby fully incorporated herein by reference.

### TECHNICAL FIELD

The present disclosure relates to a non-combustible aerosol provision system, a power module for use with the non-combustible aerosol provision system and a kit of parts.

### BACKGROUND

Articles such as cigarettes, cigars and the like burn tobacco during use to create tobacco smoke. Attempts have been made to provide alternatives to these articles, which burn tobacco, by creating products that release compounds without burning. Examples of such products are so-called heat-not-burn products, also known as tobacco heating products or tobacco heating devices, which release compounds by heating, but not burning, the material. The material may be, for example, tobacco or other non-tobacco products or a combination, such as a blended mix, which may or may not contain nicotine.

### SUMMARY

According to a first aspect of the present disclosure, there is provided a non-combustible aerosol provision device comprising: an aerosol generator configured to cause aerosol to be generated from aerosol-generating material; a first electrical power source for powering the aerosol generator; and a connector for selectively connecting the non-combustible aerosol provision device to a power module, the power module comprising a second electrical power source for powering the aerosol generator, wherein the non-combustible aerosol provision device is configured such that the non-combustible aerosol provision device is settable in a first power mode when the power module is not connected to the non-combustible aerosol provision device and is settable in a second different power mode when the power module is connected to the non-combustible aerosol provision device, wherein the first and second power modes each determines the supply of electrical power to the aerosol generator.

According to a second aspect of the present disclosure, there is provided a power module for use with the non-combustible aerosol provision device according to the first aspect, wherein: the power module is configured to supply electrical power to the non-combustible aerosol provision device via the connector.

According to a third aspect of the present disclosure, there is provided a kit of parts comprising: the non-combustible aerosol provision device according to the first aspect; a consumable article for use in the non-combustible aerosol provision device; and the power module according to the second aspect.

### BRIEF DESCRIPTION OF THE DRAWINGS

FIG. 1 is a schematic view of a non-combustible aerosol provision device according to an example.

FIG. 2 is a schematic view of a power module according to an example.

FIG. 3 is a schematic view of a non-combustible aerosol provision system, according to an example.

### DETAILED DESCRIPTION

Apparatus is known that heats aerosol-generating material to volatilize at least one component of the aerosol-generating material, typically to form an aerosol which can be inhaled, without burning or combusting the aerosol-generating material. Such apparatus is sometimes described as an “aerosol provision device”, an “aerosol generating device”, a “heat-not-burn device”, a “tobacco heating product device” or a “tobacco heating device” or similar. Similarly, there are also so-called e-cigarette devices, which typically vaporize an aerosol-generating material in the form of a liquid, which may or may not contain nicotine.

Aerosol-generating material is a material that is capable of generating aerosol, for example when heated, irradiated or energized in any other way. Aerosol-generating material may, for example, be in the form of a solid, liquid, wax or gel which may or may not contain an active substance and/or flavorants. In some examples, the aerosol-generating material may comprise an “amorphous solid”, which may alternatively be referred to as a “monolithic solid” (i.e. non-fibrous). In some examples, the amorphous solid may be a dried gel. The amorphous solid is a solid material that may retain some fluid, such as liquid, within it. In some examples, the aerosol-generating material may for example comprise from about 50 wt %, 60 wt % or 70 wt % of amorphous solid, to about 90 wt %, 95 wt % or 100 wt % of amorphous solid.

The aerosol-generating material may, for example, include one or more of tobacco, tobacco derivatives, expanded tobacco, reconstituted tobacco or tobacco substitutes. The aerosol-generating material may, for example, be a combination or a blend of materials. The aerosol-generating material may comprise one or more active substances and/or flavors, one or more aerosol-former materials, and optionally one or more other functional material. Aerosol-generating material may also be known as “smokable material”.

The active substance as used herein may be a physiologically active material, which is a material intended to achieve or enhance a physiological response. The active substance may for example be selected from nutraceuticals, nootropics, psychoactives. The active substance may be naturally occurring or synthetically obtained. The active substance may comprise for example nicotine, caffeine, taurine, theine, vitamins such as B6 or B12 or C, melatonin, cannabinoids, or constituents, derivatives, or combinations thereof. The active substance may comprise one or more constituents, derivatives or extracts of tobacco, cannabis or another botanical.

In some examples, the active substance comprises nicotine. In some examples, the active substance comprises caffeine, melatonin or vitamin B 12.

The aerosol-former material may comprise one or more constituents capable of forming an aerosol. In some examples, the aerosol-former material may comprise one or more of glycerin, glycerol, propylene glycol, diethylene glycol, triethylene glycol, tetraethylene glycol, 1,3-butylene glycol, erythritol, meso-Erythritol, ethyl vanillate, ethyl laurate, a diethyl suberate, triethyl citrate, triacetin, a diacetin mixture, benzyl benzoate, benzyl phenyl acetate, tributyrin, lauryl acetate, lauric acid, myristic acid, and propylene carbonate.

The one or more other functional materials may comprise one or more of pH regulators, coloring agents, preservatives, binders, fillers, stabilizers, and/or antioxidants.

According to the present disclosure, a “non-combustible” aerosol provision device is one where an aerosol-generating material is not combusted or burned in order to facilitate delivery of at least one substance to a user. In other words, the noncombustible aerosol provision device provides an aerosol without burning or combusting the aerosol-generating material.

In some examples, the non-combustible aerosol provision device is an electronic cigarette, also known as a vaping device or electronic nicotine delivery system (END), although it is noted that the presence of nicotine in the aerosol-generating material is not a requirement. In such examples, the non-combustible aerosol provision device vaporizes an aerosol-generating material in the form of a liquid.

In some examples, the non-combustible aerosol provision device is an aerosol generating material heating device, also known as a heat-not-burn device, tobacco heating device, etc., as described above. In such examples, the aerosol generating material may not be in liquid form.

In some examples, the non-combustible aerosol provision device is a hybrid device to generate aerosol using a combination of aerosol-generating materials. In some such examples, one or a plurality of the aerosol-generating materials may be heated. Each of the aerosol-generating materials may be, for example, in the form of a solid, liquid, wax or gel and may or may not contain nicotine. In some examples, the hybrid system comprises a liquid or gel aerosol-generating material and a solid aerosol generating material. The solid aerosol-generating material may comprise, for example, tobacco or a non-tobacco product.

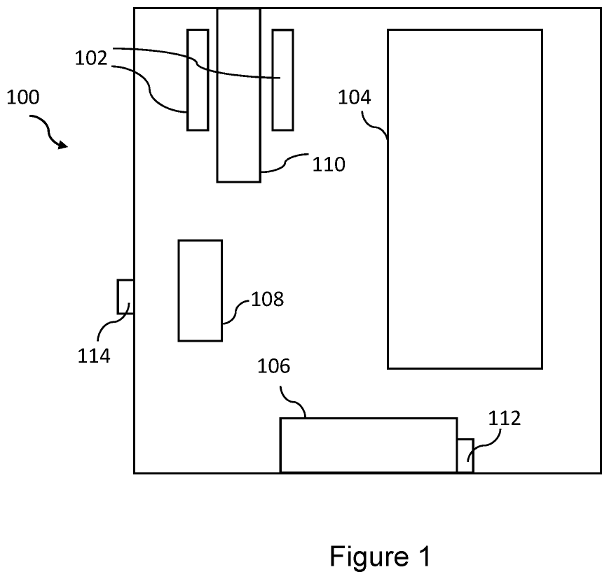

FIG. 1 illustrates an example of a non-combustible aerosol provision device 100. The non-combustible aerosol provision device 100 is hereafter referred to as the device 100 for brevity. The device 100 comprises an aerosol generator 102, a first electrical power source 104, and a connector 106. The aerosol generator 102 is configured to cause aerosol to be generated from the aerosol-generating material. The first electrical power source is for powering the aerosol generator 102. The connector 106 is for selectively connecting the device 100 to a power module. The power module (not shown in FIG. 1) comprises a second electrical power source for powering the aerosol generator 102, as described further below. The device 100 is configured such that the device 100 is settable in a first power mode when the power module is not connected to the device 100. The device 100 is settable in a second different power mode when the power module is connected to the device 100. The first and second power modes each determines the supply of electrical power to the aerosol generator 102.

The first electrical power source 104 may be a battery such as, for example, a lithium ion battery or any other type of battery suitable for use in a portable electronic device such as the device 100. The battery may be a rechargeable battery or a non-rechargeable (disposable) battery which is replaced once depleted. The electrical power source 104 may be a plurality of batteries, for example, a plurality of disposable batteries.

The aerosol generator 102 is an apparatus configured to cause aerosol to be generated from the aerosol-generating material, as described above. In some examples, the aerosol generator 102 is a heater configured to subject the aerosol-generating material to heat energy, so as to release one or more volatiles from the aerosol generating material to form an aerosol.

In some examples, the aerosol generator 102 is configured to cause an aerosol to be generated from the aerosol-generating material without heating. For example, the aerosol generator 102 may be configured to subject the aerosol-generating material to one or more of vibration, increased pressure, or electrostatic energy. In some such examples, the aerosol generator 102 comprises one or more piezo-electric elements which subject the aerosol-generating material to vibration.

In examples in which the aerosol generator 102 is a heater, it may be a resistive heater or an inductive heater, for example. Where an inductive heater is used, the inductive heater generates a varying magnetic field in order to heat one or more susceptor elements. The one or more susceptor elements may or may not form part of the aerosol generator 102 in such examples.

A susceptor material is a material that can be heated by penetration with a varying magnetic field, such as an alternating magnetic field. The susceptor material may be an electrically conductive material, so that penetration thereof with a varying magnetic field causes induction heating of the heating material. The susceptor material may be magnetic material, so that penetration thereof with a varying magnetic field causes magnetic hysteresis heating of the susceptor material. The susceptor may be both electrically conductive and magnetic, so that the susceptor can be heated by both heating mechanisms.

The following description is in the context the aerosol generator 102 being a resistive heater. However, it should be noted that the aerosol generator 102 is not so limited. The aerosol generator 102 is hereafter referred to as the heater 102 for brevity.

The first electrical power source 104 is configured to supply electrical power to the heater 102. For example, the first electrical power source 104 supplies electrical power to resistively heat the heater 102. In the example of FIG. 1, the device 100 comprises control circuitry 108 to enable the functions of the device 100 (such as circuitry for supplying electrical power from the first electrical power source 104 to the heater 102, etc.). The control circuitry 108 may determine which of the first power mode and the second power mode is to be implemented and cause electrical power to be provided to the heater 102 accordingly. The control circuitry 108 may be simple and comprise, for example, electrical connections between components of the device 100, switches, etc. In some examples, the control circuitry 108 may be more advanced. For example, the control circuitry 108 may comprise a control unit which controls various functions of the device 100. The control unit may comprise a processor in data communication with a computer readable data storage unit, where the processor implements computer readable instructions stored on the computer readable data storage unit in order to control various functions of the device 100.

The device 100 may receive a consumable article comprising aerosol-generating material for the provision of aerosol. In the example of FIG. 1, the device 100 comprises an aerosol-generation area 110 into which the consumable article is received. The heater 102 and the aerosol-generation area 110 are arranged such that aerosol generating material in an article received in the aerosol-generation area 110 is heated by the heater 102.

An “article” in this context is a component that includes or contains, in use, the aerosol-generating material, which is volatilized. The consumable article may optionally contain other components. A user may insert the consumable article into the device 100 before the production of an aerosol, which the user subsequently inhales. The consumable article may be, for example, of a predetermined or specific size that is configured to be placed within the aerosol-generation area of the device 100 which is sized to receive the consumable article. Alternatively, aerosol-generating material can simply be located in a free or unconstrained manner in an aerosol-generation area of a device; loose leaf tobacco, for example, could be used in this way. In some examples, the consumable article may be a cartridge comprising liquid aerosol-generating material. The consumable article may comprise any of the described examples of the aerosol-generating material.

In some examples, the consumable article for use with the device 100 may comprise aerosol-generating material, an aerosol-generating material storage area, an aerosol-generating material transfer component, an aerosol generator, an aerosol generation area, a housing, a wrapper, a filter, a mouthpiece, one or more susceptor elements, and/or an aerosol-modifying agent.

In the context of the aerosol generator 102 being a heater, the aerosol-generation area 110 may be referred to as a heating chamber 110. The heater 102 is arranged in the device 100 so as to provide heat to the aerosol-generating material in a consumable article received in the heating chamber 110 to volatilize at least one component of the aerosol-generating material.

The connector 106 may allow a physical connection to be made between the device 100 and the power module (not shown in FIG. 1). The connector 106 may enable electrical power to be supplied from the power module, when the power module is connected to the device 100, to the heater 102. While the connector 106 enables the power module to be connected, the device 100 is nevertheless usable for aerosol provision without the power module being connected. For example, electrical power from the first electrical power source 104 is supplied to the heater 102 which thereby generates heat to volatilize at least one component of the aerosol-generating material to provide an aerosol for inhalation. Connection of the power module provides additional functionality as described further below.

In some examples, the connector 106 may comprise conductive contact pads/pins which contact complementary pads/pins on the power module when the power module is connected via the connector 106, thereby enabling transfer of electrical power from the power module to the device 100. The connector 106 may also comprise a device-side mechanical connection mechanism which engages with a complementary module-side mechanical connection mechanism to securely attach the power module to the device 100. In some examples, the same mechanism performs the functions of securely attaching the power module to the device 100. In other examples, the connector 106 comprises one mechanism for the supply of electrical power and another mechanism for securing the power module to the device 100.

In some examples, known types of connectors which allow electronic devices to be connected to one another may be used. For example, the connector 106 may comprise a male or female portion of a connector, such as a USB Type C connector, which engages with a complementary connector on the power module (described further below). Various different connectors may be used. For example, USB Type A, USB Type B, USB Type A Mini, USB Type B Micro, or proprietary connector etc. The connector may be of a type other than a USB connector. The connector 106 may be of any type which enables the transfer of electrical power from the power module and, in some examples, a control signal from the power module to the device 100.

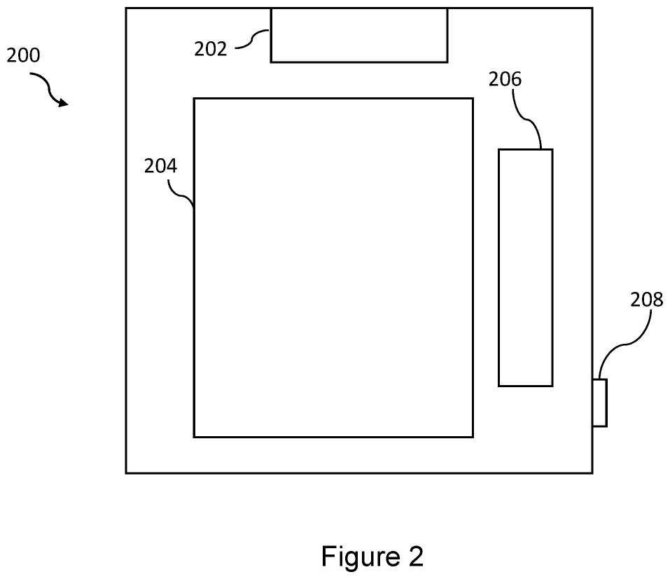

FIG. 2 is a schematic view of an example 200 of the power module. The power module 200 is configured to supply electrical power to the device 100 via the connector 106. More specifically, in the example of FIG. 2, the power module comprises a module-side connector 202. The specific features of the module-side connector 202 depend on the type of connector 106 provided in the device 100. For example, if the abovementioned contact pads/pins are used, the module-side connector 202 comprises complementary pads/pins. The module-side connector 202 is configured to engage with the connector 106 of the device 100 so as to supply electrical power to the heater 102. The module-side connector 202 comprises complimentary connecting means for forming an electrical power supply connection with the connector 106 and for forming a mechanical connection for secure attachment.

The power module 200 comprises a second electrical power source 204 for powering the heater 102. The second electrical power source 204 stores the electrical power which is supplied to the heater 102 via the connector 106. The second electrical power source 204 may be a battery such as, for example, a lithium ion battery or any other type of battery suitable for use in a portable electronic device such as the device 100 and/or the power module 200. For example, the second electrical power source 204 may be a rechargeable battery or a non-rechargeable (disposable) battery which is replaced once depleted. The electrical power source 104 may be a plurality of batteries, for example, a plurality of disposable batteries.

In the example of FIG. 2, the power module 200 comprises module-side control circuitry 206 to enable the functions of the power module 200 (such as circuitry for supplying electrical power from the second electrical power source 204 to the module side connector 202 such that electrical power can be transferred from the module-side connector 202 to the connector 106 of the device 100 and to the heater 102). The module-side control circuitry 206 may be simple and comprise, for example, electrical connections between components of the power module 200, switches, etc. In some examples, the module-side control circuitry 206 may be more advanced. For example, the module-side control circuitry 206 may comprise a module-side control unit which controls various functions of the power module 200. The module-side control unit may comprise a processor in data communication with a computer readable data storage unit, where the processor implements computer readable instructions stored on the computer readable data storage unit in order to control various functions of the power module 200. In some examples, the module-side control circuitry 206 may additional control one or more functions of the device 100 when the module 200 is connected to the device 100 via the module-side connector 202 and the connector 106 of the device 100. In some examples, the module-side control circuitry 206 may determine which of the first power mode and the second power mode is to be implemented and cause electrical power to be provided to the heater 102 accordingly.

As described above, the device 100 is settable in the first power mode or in the second power mode based on whether or not the power module is connected to the device 100, and the power mode determines the supply of electrical power to the heater 102. The first power mode may be a low power mode and the second power mode may be a high power mode. The high power mode is a mode in which greater electrical power is supplied to the aerosol generator relative to the electrical power supplied to the aerosol generator in the low power mode.

Accordingly, the device 100 is settable in the low power mode when the power module 200 is not connected to the device 100 and is settable in the high power mode when the module 200 is connected to the device 100. The power module 200 supplies electrical power to the heater 102 in the high power mode. In the high power mode, the relevant circuitry of the device 100 is arranged such that the heater 102 is supplied with additional electrical power relative to the low power mode, which additional electrical power is contributed by the power module 200 (specifically the second electrical power source 204 of the power module 200).

Advantageously, by supplying different amounts of electrical power to the heater 102 according to the power mode, the provision of aerosol can be affected. For example, in the high power mode, more electrical energy is supplied to the heater 102 per unit time. Therefore, the heater 102 reaches higher temperatures and thus imparts more heat to the aerosol-generating material. In doing so, the characteristics of the aerosol generated are affected. For example, in high power mode, certain constituents of the aerosol-generating material may be volatilized which constituents are not volatilize in the low power mode. This may change the flavor or texture of the resulting aerosol, for example. For example, in high power mode, a greater quantity of the at least one component of the aerosol-generating material may be volatilized per unit time. This may provide stronger aerosol per puff for the user, for example.

Accordingly, by implementing a high power mode and a low power mode, the user is provided with aerosol with differing characteristics using the same device and the same aerosol-generating material. The magnitude of electrical power supplied to the heater 102 and the difference in electrical power between the higher power mode and the low power mode depends on the device characteristics and the characteristics of the aerosol-generating materials intended to be used with the device 100. In a specific example, electrical power between 6.5 watts and 8 watts is supplied to the heater 102 in the low power mode, and electrical power between 8 watts and 10 watts is supplied to the heater 102 in the high power mode.

The first electrical power source 104 of the device 100 may not be powerful enough to supply the greater electrical power according to the high power mode or it may be very quickly depleted if it were to be used as the sole electrical power source in the high power mode. Accordingly, by implementing the high power mode when the power module 200 is connected, the device 100 can be provided with a smaller and/or less powerful electrical power source which is sufficient for the low power mode.

In some examples, the power mode may automatically be set to the high power mode responsive to the power module 200 being connected to the device 100. For example, connecting the power module 200 to the connector 106 may engage a power mode switch (which may be an internal component of the device 100 and part of the control circuitry 108 therein). In such examples, when the power mode switch is engaged, it causes greater electrical power to be supplied to the heater 102 according to the high power mode during use (e.g. when the heater 102 is drawing electrical power to heat aerosol-generating material during use). In such examples, connecting the power module 200 alters the functioning of the control circuitry 108 of the device 100 to implement the high power mode automatically.

The control circuitry 108 of the device 100 may be configured to detect whether or not the power module 200 is connected to the device 100. Alternatively, or in addition, the module-side control circuitry 206 may be configured to detect whether or not the power module 200 is connected to the device 100. The power mode may be set based on the result of such detection. For example, the control circuitry 108 of the device 100 and/or the module-side control circuitry 206 may be configured to detect whether or not the power module 200 is connected to the device 100 based on a signal indicating that the power module 200 is connected to the device 100. The signal may be an electrical signal. The power module 200 is for supplying electrical power. When the power module 200 is connected to the device 100, an electrical connection is made between the power module 200 and the device 100 via the module-side connector 202 and the connector 106 of the device 100. Therefore, when the power module 200 is connected such that it can supply electrical power to the device 100, it affects the behavior of the control circuitry 108 of the device 100 and the module-side control circuitry 206. Connecting the device 100 and the power module 200 together electrically may change certain characteristics of the control circuitry 108 of the device 100 and the module-side control circuitry 206. In some examples, a change in a characteristic (a voltage, a current, a resistance, a capacitance, an inductance, a combination of these, etc.) of the control circuitry 108 of the device 100 and/or the module-side control circuitry 206 may constitute the signal. The signal may be detected by a detector which detects a change in a voltage, a current, a resistance, a capacitance, an inductance, a combination of these, etc., as the case may be. The device 100 and/or the power module 200 may comprise such a detector. The detector may generate and send the signal which indicates the change in the relevant characteristic to the control circuitry 108 of the device 100 or the module-side control circuitry 206, as the case may be.

For example, the power module 200 may alter the voltage across certain components of the control circuitry 108 of the device 100. In some examples, the device 100 may comprise a voltage detector 112 (an example of a detector as discussed above) for detecting a voltage in relation to the connector 106. The voltage detector 112 detects a different voltage at the connector 106 when the power module 200 is connected to the device 100 via the connector 106. In such examples, the signal indicating that the power module 200 is connected may be provided by the voltage detector 112. In a simple example, the voltage detector 112 may provide a signal to circuit components of the control circuitry 108 which engage the described power mode switch. Alternatively, or in addition, the power module 200 may comprise a module-side voltage detector (not shown in FIG. 2) which provides a signal based on a voltage change at the module-side connector 206, for example. Various different methods may be used to provide the described signal. In some examples, the signal may be provided by a switch which is engaged when the power module 200 forms a mechanical connection at the connector 106, and the like. In the described example where a switch is engaged when the power module 200 forms a mechanical connection at the connector 106, that switch may be the described power mode switch.

The control circuitry 108 may set the power mode of the device 100 to the high power mode based on receipt of the signal, for example. In some examples, the connector 106 enables data communication between the power module 200 and the device 100. For example, data may be communicated between control circuitry 108 and the module-side control circuitry 206 via the connector 108 of the device 100 and the module-side connector 206.

In some such examples, the module-side control circuitry 206 may detect that the power module 200 is connected to the device 100 and communicate this to the control circuitry 108 of the device 100 via the respective connectors, which may then set the power mode of the device 100. In some examples, the module-side control circuitry 206 may assume control of setting the power mode of the device 100. For example, the control circuitry 108 of the device 100 may determine (based on the signal) that the power module 200 is connected and hand over control to the module-side control circuitry 206. For example, the module-side control circuitry 206 may determine (based on the signal) that the power module 200 is connected, and request and obtain control of the power mode of the device 100. For example, both the control circuitry 108 and the module-side control circuitry 206 may determine that the power module 200 is connected (based on respective signals as described above) and implement a protocol for the module-side control circuitry to take control of setting the power mode.

In examples where the power mode is set to the high power mode responsive to the power module 200 being connected automatically, the presence of the signal may cause the power mode to be set to the high power mode in any manner described above.

In some examples, the power mode may not be set to the high power mode automatically. The power mode may be set to the high power mode when the power module 200 is connected to the device 100 and responsive to a user input. In other words, in some examples, a user input may be required to set the power mode to the high power mode. In some examples, the device 100 comprises a user input unit for receiving the user input. In the example of FIG. 1, the device 100 comprises an input unit 114. The user input unit 114 may be in various forms such as one or more buttons, one or more switches, a touch sensitive user interface and the like. Alternatively, or in addition, the user input may be received from a user input unit 208 of the power module 200. The module-side user input unit 208 may also be in various forms such as one or more buttons, one or more switches, a touch sensitive user interface and the like.

In some examples, the user may determine whether the power mode is to be set to the high power mode automatically when the power module is connected, or whether user input is required. The user may input the relevant instruction using the input unit 114 of the device 100 or the module-side input unit 208, as the case may be. As described above, either the control circuitry 108 or the module-side control circuitry 206 may set the power mode to the high power mode. The relevant control circuitry may receive the user input from the input unit 114 of the device 100 or the module-side input unit 208, as the case may be.

In examples where the power mode is not set to the high power mode automatically when the power module 200 is connected and the device 100 is used in the low power mode, the power module 200 may be used to enhance the battery life of the device 100 and power module 200 system. In such examples, the second electrical power source 204 of the power module 200 may charge the electrical power source 104 of the device 100. Alternatively, or in addition, the power module 200 may supply electrical power to the heater 102 when it is operating in the low power mode to extend overall battery life in the low power mode.

The power module 200 may comprise additional module-side connectors apart from the module-side connector 202 shown in the example of FIG. 2. The power module 200 may be combined with other modules which comprise such module-side connectors such that the device 100 is connected to a plurality of modules. Each of the different modules may provide different functionality. For example, a user interface module may be connected which provides a more advanced user interface compared to the user interface on the device 100.

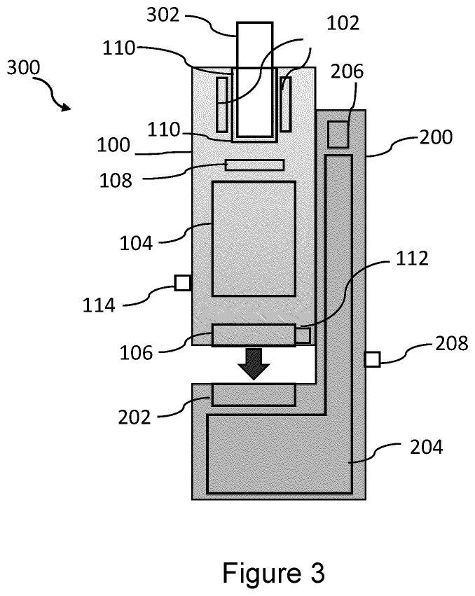

FIG. 3 is a schematic sketch of an example non-combustible aerosol provision system 300. The system 300 comprises the device 100 and the power module 200. In the example of FIG. 3, when the power module 200 is connected to the device 100 via the connector 106, the power module 200 partially surrounds the device 100. In some examples, the device 100 may comprise a tubular housing or sleeve. In such examples, the power module 200 covers, either entirely or partially, the circumference of the device 100. Such an arrangement improves the strength and durability of the connection between the device 100 and power module 200, and provides a robust system overall. Such an arrangement may reduce the likelihood of the connection being accidentally broken during use, for example. Such an arrangement may also, in use, be more ergonomic and provide more seamless integration than other arrangements, allowing for increased user comfort. As illustrated in FIG. 3, the device 100 and the power module 200 are configured such that the device 100 may be slid into place in order to connect to the power module 200. In such an arrangement, the power module 200 and the device 100 assists in properly aligning the connector 106 and the module-side connector 202; for example a housing of the power module 200 may comprise a guiding groove into which a protrusion located on the housing of the power module 200 may be slid in order to properly align the connector 106 of the device 100 and the module-side connector 202. The shape of the power module 200 as shown in FIG. 3 advantageously allows the power module 200 to house a larger second electrical power source 204 without further increasing the overall length of the system 300.

FIG. 3 also shows a consumable article 302 received in the device 100. There may be provided a kit of parts comprising the device 100, the power module 200 and the consumable article 302.

The above examples are to be understood as illustrative examples of the disclosure. Further examples of the disclosure are envisaged. It is to be understood that any feature described in relation to any one example may be used alone, or in combination with other features described, and may also be used in combination with one or more features of any other of the examples, or any combination of any other of the examples. Furthermore, equivalents and modifications not described above may also be employed without departing from the scope of the disclosure, which is defined in the accompanying claims

1. A non-combustible aerosol provision device comprising:
an aerosol generator configured to cause aerosol to be generated from aerosol-generating material;
a first electrical power source for powering the aerosol generator; and
a connector for selectively connecting the non-combustible aerosol provision device to a power module, the power module comprising a second electrical power source for powering the aerosol generator;
wherein the non-combustible aerosol provision device is settable in a first power mode when the power module is not connected to the non-combustible aerosol provision device and is settable in a second power mode different from the first power mode when the power module is connected to the non-combustible aerosol provision device, wherein the first power mode and the second power mode each determines a supply of electrical power to the aerosol generator.

2. The non-combustible aerosol provision device according to claim 1, wherein the connector enables electrical power to be supplied from the power module to the aerosol generator.

3. The non-combustible aerosol provision device according to claim 2, wherein:
the first power mode is a low power mode and the second power mode is a high power mode, and
the high power mode is a mode in which greater electrical power is supplied to the aerosol generator relative to electrical power supplied to the aerosol generator in the low power mode.

4. The non-combustible aerosol provision device according to claim 3, wherein the power module supplies electrical power to the aerosol generator in the high power mode.

5. The non-combustible aerosol provision device according to claim 3, wherein a power mode is automatically set to the high power mode responsive to the power module being connected to the aerosol generating device.

6. The non-combustible aerosol provision device according to claim 3, wherein a power mode is set to the high power mode when the power module is connected to the non-combustible aerosol provision device and responsive to a user input.

7. The non-combustible aerosol provision device according to claim 6, further comprising a user input unit for receiving the user input.

8. The non-combustible aerosol provision device according to claim 6, wherein the user input is received from a module-side user input unit of the power module.

9. The non-combustible aerosol provision device according to claim 1, further comprising control circuitry configured to detect whether or not the power module is connected to the non-combustible aerosol provision device.

10. The non-combustible aerosol provision device according to claim 9, wherein the control circuitry is configured to detect whether or not the power module is connected to the non-combustible aerosol provision device based on a signal indicating that the power module is connected to the non-combustible aerosol generating device.

11. The non-combustible aerosol provision device according to claim 10, wherein:
the connector enables data communication between the power module and the non-combustible aerosol provision device; and
the signal is received from the power module via the connector.

12. The non-combustible aerosol provision device according to claim 10, further comprising:
a voltage detector for detecting a voltage in relation to the connector,
wherein the signal is provided by the voltage detector.

13. The non-combustible aerosol provision device according to claim 3, wherein:
in the low power mode, electrical power between 6.5 watts and 8 watts is supplied to the aerosol generator; and
in the high power mode, electrical power between 8 watts and 10 watts is supplied to the aerosol generator.

14. A power module for use with the non-combustible aerosol provision device according to claim 1, wherein the power module is configured to supply the electrical power to the non-combustible aerosol provision device via the connector.

15. A kit of parts comprising:
the non-combustible aerosol provision device according to claim 1;
a consumable article for use in the non-combustible aerosol provision device; and
the power module configured to supply the electrical power to the non-combustible aerosol provision device via the connector.
